(19) United States
(12) Patent Application Publication
(10) Pub. No.: US 2012/0025963 A1
(43) Pub. Date: Feb. 2, 2012

(54) VEHICLE USING MOTOR AND METHOD OF CONTROLLING THE SAME

(76) Inventors: Han-Seok Yun, Yongin-si (KR); Susumu Segawa, Yongin-si (KR); Eui-Jeong Hwang, Yongin-si (KR); Se-Sub Sim, Yongin-si (KR); Jong-Woon Yang, Yongin-si (KR); Beom-Gyu Kim, Yongin-si (KR); Jin-Wan Kim, Yongin-si (KR)

(21) Appl. No.: 13/011,738

(22) Filed: Jan. 21, 2011

(30) Foreign Application Priority Data
Jul. 28, 2010 (KR) 10-2010-0072973

(51) Int. Cl. B62J 6/00; B60Q 1/00

(52) U.S. Cl. 340/432; 340/455

(57) ABSTRACT

A vehicle using a motor, and a method of controlling the vehicle. The vehicle includes a battery for providing electric energy to the motor, a remaining energy-amount detector for detecting an amount of remaining energy of the battery, a distance calculator for calculating an available moving distance of the vehicle corresponding to the amount of remaining energy and a weight applied to the vehicle, and a display unit for displaying the available moving distance.

### CROSS-REFERENCE TO RELATED APPLICATIONS

This application claims priority to and the benefit of Korean Patent Application No. 10-2010-0072973, filed on Jul. 28, 2010, in the Korean Intellectual Property Office, the disclosure of which is incorporated herein in its entirety by reference.

### BACKGROUND

1. Field

Aspects of embodiments according to the present invention relate to vehicles using motors, and methods of controlling the same.

2. Description of Related Art

Recently, as the environment has been seriously polluted, attention to green technologies has been increased, and green technologies are amongst new growth engine industries. By virtue of increased interest in green technologies, electric bicycles have received attention.

An electric bicycle has wheels that may be rotated by a motor. The motor receives electricity from a battery, and thus, a capacity of the battery is very important. Recently, along with developments of secondary batteries, capacities of batteries are greatly improving, and circumstances related to electric bicycles may change, for example, bike lanes may be expanded. Thus, use of electric bicycles may become more widely used.

### SUMMARY

One or more embodiments of the present invention include vehicles using motors for enabling a user to move a distance, and methods of controlling the vehicles.

Additional aspects will be set forth, in part, in the description which follows and, in part, will be apparent from the description, or may be learned by practice of the presented embodiments.

According to one or more embodiments of the present invention, a vehicle using a motor includes a battery for providing electric energy to the motor, a remaining energy-amount detector for detecting an amount of remaining energy of the battery, a distance calculator for calculating an available moving distance of the vehicle corresponding to the amount of remaining energy and a weight applied to the vehicle, and a display unit for displaying the available moving distance.

The vehicle may further include a sensor for measuring the weight applied to the vehicle.

The sensor may be coupled to a riding portion configured for a user to ride on.

The sensor may be coupled to a device for supporting transfer portion of the vehicle.

The vehicle may further include an input portion for inputting data corresponding to the weight applied to the vehicle.

The vehicle may be configured to operate in an operation mode of operation modes including a first mode using the electric energy of the battery, and a second mode using the electric energy of the battery and mechanical energy applied by a user.

The distance calculator may be configured to calculate the available moving distance according to whether the operation mode is the first mode or the second mode.

The distance calculator may be configured to calculate the available moving distance according to a variation of the mechanical energy applied by the user when the operation mode is the second mode.

The battery and the remaining energy-amount detector may be integrated together as a battery pack.

The vehicle may be an electric bicycle.

According to one or more embodiments of the present invention, a method of controlling a vehicle using a motor includes detecting an amount of remaining energy of a battery, calculating an available moving distance of the vehicle corresponding to the amount of remaining energy and a weight applied to the vehicle, and displaying the available moving distance.

The method may further include detecting the weight applied to the vehicle.

The method may further include inputting data corresponding to the weight applied to the vehicle.

The method may further include determining an operation mode of the vehicle, wherein the available moving distance of the vehicle is calculated in consideration of the operation mode.

The method may further include calculating the available moving distance according to a variation of a mechanical energy applied by a user when the operation mode of the vehicle uses electric energy of the battery and the mechanical energy applied by the user.

### BRIEF DESCRIPTION OF THE DRAWINGS

These and/or other aspects will become apparent and more readily appreciated from the following description of embodiments of the invention, taken in conjunction with the accompanying drawings of which:

FIG. 1 is a block diagram of a vehicle using a motor, according to embodiments of the present invention;

FIG. 2 is a diagram of the vehicle of FIG. 1, according to an embodiment of the present invention;

FIG. 3 is a diagram of the vehicle of FIG. 1, according to another embodiment of the present invention;

FIG. 4 is a flowchart of a method of controlling the vehicle of FIG. 1, according to an embodiment of the present invention;

FIG. 5 is a block diagram of a vehicle using a motor, according to another embodiment of the present invention;

FIG. 6 is a flowchart of a method of controlling the vehicle of FIG. 5, according to another embodiment of the present invention; and

FIG. 7 is a block diagram of a vehicle using a motor, according to another embodiment of the present invention.

### DETAILED DESCRIPTION

Reference will now be made in detail to embodiments of the present invention, examples of which are illustrated in the accompanying drawings, wherein like reference numerals refer to the like elements throughout, and thus, overlapping descriptions will be omitted. Also, while describing embodiments of the present invention, detailed descriptions about related well-known functions or configurations that may not be required for a complete understanding of the present invention may also be omitted.

Terms or words used herein shall not be limited to their common or dictionary meanings, but will also have a meaning corresponding to technical aspects of embodiments of the present invention so as to most suitably express embodiments of the present invention.

FIG. 1 is a block diagram of a vehicle 1 using a motor 21, according to embodiments of the present invention.

Referring to FIG. 1, the vehicle 1 may include a battery 10, a driver 20, the motor 21, a pedal 22, a transfer portion 30, a remaining energy-amount detector 40, a controller 41, a torque detector 42, a display unit 50, and a sensor 60.

The battery 10 may include one or more bare cells, and may include a protection circuit for controlling charging and discharging of the bare cells. The battery 10 may be a rechargeable secondary battery, and may include a connection terminal for charging the battery 10. The battery 10 stores electric energy by being charged, and provides the stored electric energy to the motor 21.

The driver 20 receives a control signal from the controller 41, and applies a driving signal to the motor 21.

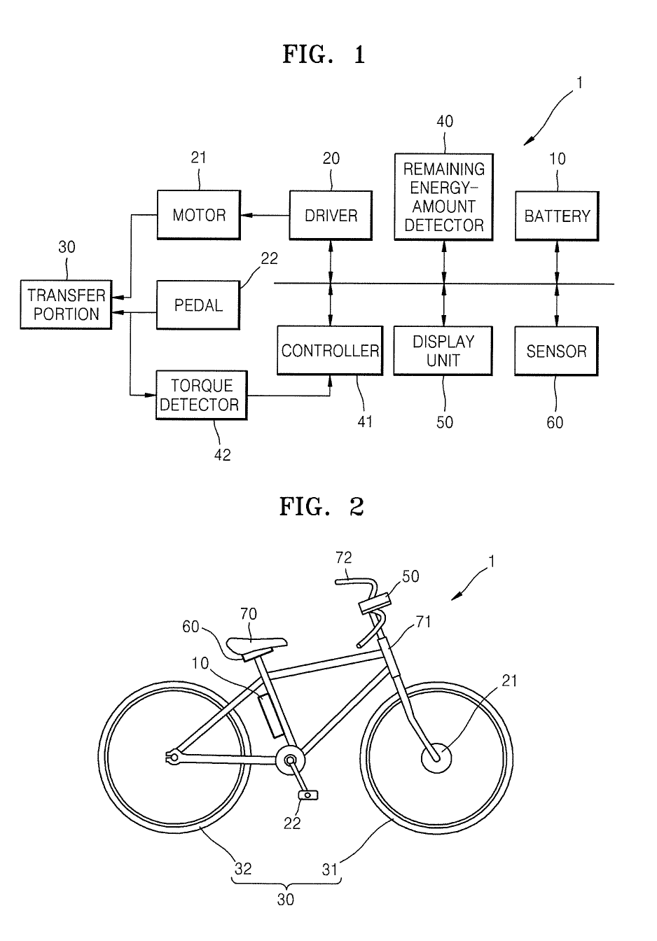

The motor 21 operates the transfer portion 30 (e.g., an energy transfer portion, or a device for facilitating motion of the vehicle 1) according to the driving signal. For example, with regard to a bicycle (e.g., vehicle 1 of FIG. 2), the motor 21 may rotate wheels (e.g., wheel 31 of FIG. 2) according to the driving signal so that the electric bicycle may proceed (e.g., may be propelled forward). The motor 21 receives the electric energy stored in the battery 10 from the battery 10 so as to be driven. The motor 21 is connected (e.g., connected directly) to the transfer portion 30, which may be a wheel, so as to operate the transfer portion 30. Alternatively, the motor 21 may operate the transfer portion 30 through a chain or a gear.

The pedal 22 transfers power applied by a user to the transfer portion 30. When the pedal 22 performs a rotary motion, a torque (or other mechanical energy) applied by the user is transmitted to the transfer portion 30.

The transfer portion 30 may move the vehicle 1 by using power transferred from the motor 21 or the pedal 22 or both. The transfer portion 30 may be front and/or rear wheels 31 and 32 (see FIG. 2), tracks, or the like.

The remaining energy-amount detector 40 monitors a voltage or current output from the battery 10 so as to detect a remaining energy-amount (e.g., an amount of energy remaining, or a charge level) of the battery 10. The remaining energy-amount detector 40 transmits data regarding the remaining energy-amount of the battery 10 to the controller 41.

The controller 41 may control a whole operation of the vehicle 1. The controller 41 calculates an expected moving distance (e.g., available moving distance before the charge of the battery 10 is drained) of the vehicle 1 based on data regarding a remaining energy-amount of the battery 10, which is received from the remaining energy-amount detector 40, and weight data received from the sensor 60. That is, the controller 41 may be an example of a distance calculator (e.g., an approximator of a maximum available operational distance of the motor 21 based on current charge level of the battery 10).

The vehicle 1 may operate in any one operation mode of various operation modes. For example, the vehicle 1 may have an “auto mode” in which the vehicle 1 operates by using only the electric energy stored in the battery 10, and an “assist mode” in which the vehicle 1 operates by using both the electric energy stored in the battery 10 and a torque applied by the user. In addition, the vehicle 1 may have a “manual mode” in which the vehicle 1 operates by using only a torque applied by the user.

Thus, the controller 41 may calculate an available moving distance (e.g., an expected range the vehicle 1 may travel before a charge of the battery 10 is drained) according to an operation mode that is currently selected.

When the vehicle 1 operates in the auto mode, the controller 41 may calculate the remaining energy-amount of the battery 10 and a weight applied to (e.g., supported by) the vehicle 1, and may transmit the calculated result to the display unit 50.

On the other hand, when the vehicle 1 operates in the assist mode, the available moving distance may be further determined (e.g., by the controller 41) by a torque applied by the user. Thus, when the vehicle 1 operates in the assist mode, the controller 41 may reflect a result of detecting an applied torque from the torque detector 42 in calculating the available moving distance. For example, when a torque applied by the user is relatively great, the calculated available moving distance may be increased. When a torque applied by the user is relatively small, the calculated available moving distance may be reduced. In addition, since the size of a torque (e.g., the amount of torque) applied by the user may not be constant, the controller 41 may repeatedly calculate the available moving distance according to variations of the applied torque. The controller 41 transmits the most recently calculated available moving distance to the display unit 50.

The torque detector 42 detects a torque that is applied (e.g., to the pedal 22) by the user, in real time, and the detected result is applied (e.g., communicated) to the controller 41. Data regarding the detected torque may be used by the controller 41 to calculate the available moving distance in the assist mode.

The display unit 50 displays the available moving distance, which is transmitted from the controller 41, to the user. The display unit 50 may include a display panel, such as a liquid crystal display (LCD) or an organic light emitting display (OLED), and a driver thereof.

The sensor 60 measures a weight applied to the vehicle 1. The sensor 60 may be appropriately installed at a location (e.g., a predetermined location) on the vehicle so as to correctly measure the weight applied to the vehicle 1. For example, the sensor 60 may be installed in a riding portion on which the user may ride (e.g., sit), or a device for supporting the transfer portion 30.

FIG. 2 is a diagram of the vehicle 1 of FIG. 1, according to an embodiment of the present invention.

Referring to FIG. 2, an electric bicycle is shown as the vehicle 1.

Front and rear wheels 31 and 32 as the transfer portion 30 are connected to a frame 71, and the motor 21 is installed at the front wheel 31. The battery 10 is also installed at, or on, the frame 71.

A saddle 70 (e.g., bicycle seat) for the user to ride on (e.g., for supporting the user) is provided. The sensor 60 for detecting a weight applied to the vehicle 1 may be installed under the saddle 70.

A handle 72 (e.g., handlebars) functions as a steering device by determining a direction of the front wheel 31. In addition, the handle 72 may support (e.g., additionally support) the user's body.

The display unit 50 is disposed in the middle of the handle 72 so that the user may easily check the available moving distance.

The frame 71 may support each component of the electric bicycle.

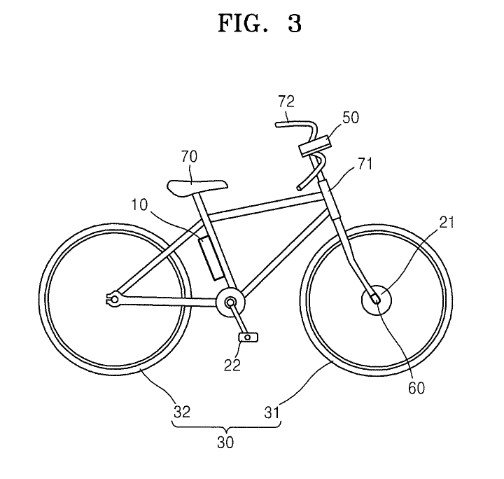

FIG. 3 is a diagram of the vehicle 1 of FIG. 1, according to another embodiment of the present invention.

Referring to FIG. 3, the vehicle 1 of FIG. 3 is substantially the same as the vehicle 1 of the embodiment of the present invention shown in FIG. 2. However, the vehicle 1 of FIG. 3 is different from the vehicle 1 shown in FIG. 2 in that the sensor 60 for detecting a weight applied to the vehicle 1 is installed at the frame 71.

The configurations of the electric bicycles of FIGS. 2 and 3 are just exemplary embodiments of the present invention, and thus, may be variously changed without departing from the spirit and scope of the present invention.

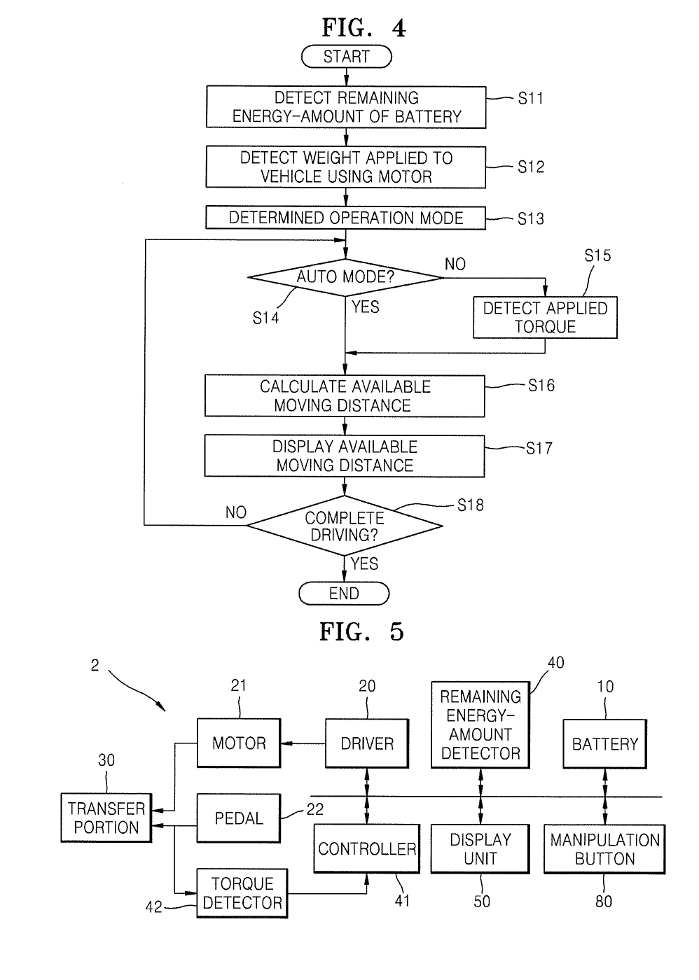

FIG. 4 is a flowchart of a method of controlling the vehicle 1 of FIG. 1, according to an embodiment of the present invention.

The remaining energy-amount detector 40 detects a remaining energy-amount of the battery 10 (operation S11). When a user rides the vehicle 1, a weight applied to the vehicle 1 is detected (operation S12).

The controller 41 determines an operation mode of the vehicle 1 (operations S13 and S14). When the vehicle 1 operates in the assist mode, the size of a torque applied by the user is detected (operation S15).

In addition, the controller 41 calculates an expected available moving distance, based on the remaining energy-amount of the battery 10, the weight applied to the vehicle 1, and the size of the torque applied by the user (operation S16). The calculated expected available moving distance is transmitted to the display unit 50, and is displayed on the display unit 50 (operation S17).

It is determined whether driving of the vehicle 1 is completed (operation S18). When the driving is not completed, the method returns to operation S14, and any of the previous operations are performed again.

According to the present embodiment, in operation S18, when the driving is not completed, the method may return to operation S14, but the present invention is not limited thereto. For example, the method may return to operation S11, and the remaining energy-amount of the battery 10 may be detected again.

FIG. 5 is a block diagram of a vehicle 2 using a motor, according to another embodiment of the present invention. The vehicle 2 of FIG. 5 has a construction and a function similar to those of the vehicle 1 of FIG. 1, and thus, will be described in terms of its differences from the electric vehicle 1 of FIG. 1.

The vehicle 2 includes a manipulation button 80 (e.g., input portion). The manipulation button 80 applies a manipulation signal to the controller 41 according to a user's input. The user may, as desired, input his or her weight, or a weight applied to the vehicle 2, by using the manipulation button 80. That is, the manipulation button 80 may be an example of an element for inputting a weight (e.g., data corresponding to a weight applied to the vehicle 2).

The controller 41 calculates an available moving distance, based on the remaining energy-amount of the battery 10, which is detected by the remaining energy-amount detector 40, and weight information input by the user.

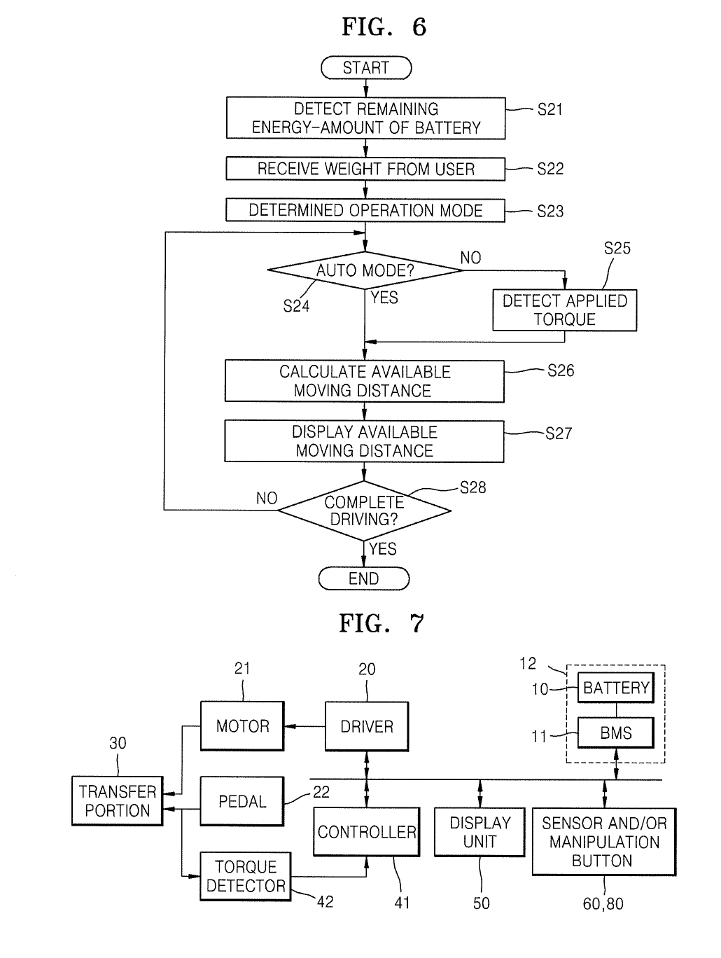

FIG. 6 is a flowchart of a method of controlling the vehicle 2 of FIG. 5, according to another embodiment of the present invention.

Referring to FIG. 6, the method of FIG. 6 is materially the same as the method of FIG. 4. However, the method of FIG. 6 is different from the method of FIG. 4 in that weight information input by the user is applied to the controller 41, and is used to calculate an available moving distance, rather than being detected by the sensor 60 (see S12 of FIG. 4 and S22 of FIG. 6).

FIG. 7 is a block diagram of a vehicle 3 using a motor, according to another embodiment of the present invention. The vehicle 3 of FIG. 7 has a construction and a function similar to those of the vehicle 1 of FIG. 1, and thus, will be described in terms of differences from the electric vehicle 1 of FIG. 1.

The vehicle 3 may include a battery pack 12 in which the battery 10 and a battery management system (BMS) 11 are integrated (e.g., integrated with each other).

The BMS 11 is connected to the battery 10 so as to control charging and discharging operations of the battery 10. The BMS 11 may perform an overcharging protection function, an overdischarging protection function, an overcurrent protection function, an overvoltage protection function, an overheat protection function, a cell balancing function, and/or the like, in order to protect the battery 10. To this end, the BMS 11 may monitor voltage, current, temperature, remaining energy-amount, lifetime, charging state, and/or the like of the battery 10, and may transmit related information to the controller 41. That is, the BMS 11 may function as the remaining energy-amount detector 40.

In addition, when the controller 41 calculates an available moving distance, the controller 41 uses information regarding the remaining energy-amount of the battery 10, which is received from the BMS 11.

In a typical electric bicycle, a state of a battery is displayed via a light-emitting diode (LED), or the like. Thus, a user may guess an approximately available moving distance, based on the state of the battery.

However, according to one or more of the above embodiments of the present invention, the vehicles 1, 2, and 3 may provide calculated available moving distances based on the remaining energy-amount of the battery 10 and a weight applied to the vehicles 1, 2, and 3.

A program for executing the method of controlling the electric vehicle 1, 2, or 3 may be stored in a recording medium. The recording medium may be a processor readable medium such as a semiconductor recording medium (e.g., a flash medium). The recording medium may be read by a processor, and the program may be executed by the processor.

It should be understood that the exemplary embodiments described therein should be considered in a descriptive sense only and not for purposes of limitation. Descriptions of features or aspects within each embodiment should typically be considered as available for other similar features or aspects in other embodiments. Furthermore, the invention is intended to cover various modifications and equivalent arrangements of the aforementioned embodiments included within the spirit and scope of the appended claims, as well as their equivalents.

What is claimed is:

1. A vehicle using a motor, the vehicle comprising:
a battery for providing electric energy to the motor;
a remaining energy-amount detector for detecting an amount of remaining energy of the battery;
a distance calculator for calculating an available moving distance of the vehicle corresponding to the amount of remaining energy and a weight applied to the vehicle; and
a display unit for displaying the available moving distance.

2. The vehicle of claim 1, further comprising a sensor for measuring the weight applied to the vehicle.

3. The vehicle of claim 2, wherein the sensor is coupled to a riding portion configured for a user to ride on.

4. The vehicle of claim 2, wherein the sensor is coupled to a device for supporting a transfer portion of the vehicle.

5. The vehicle of claim 1, further comprising an input portion for inputting data corresponding to the weight applied to the vehicle.

6. The vehicle of claim 1, wherein the vehicle is configured to operate in an operation mode of operation modes comprising: a first mode using the electric energy of the battery; and a second mode using the electric energy of the battery and mechanical energy applied by a user.

7. The vehicle of claim 6, wherein the distance calculator is configured to calculate the available moving distance according to whether the operation mode is the first mode or the second mode.

8. The vehicle of claim 7, wherein the distance calculator is configured to calculate the available moving distance according to a variation of the mechanical energy applied by the user when the operation mode is the second mode.

9. The vehicle of claim 1, wherein the battery and the remaining energy-amount detector are integrated together as a battery pack.

10. The vehicle of claim 1, wherein the vehicle is an electric bicycle.

11. A method of controlling a vehicle using a motor, the method comprising:
detecting an amount of remaining energy of a battery;
calculating an available moving distance of the vehicle corresponding to the amount of remaining energy and a weight applied to the vehicle; and
displaying the available moving distance.

12. The method of claim 11, further comprising detecting the weight applied to the vehicle.

13. The method of claim 11, further comprising inputting data corresponding to the weight applied to the vehicle.

14. The method of claim 11, further comprising determining an operation mode of the vehicle, wherein the available moving distance of the vehicle is calculated in consideration of the operation mode.

15. The method of claim 14, further comprising calculating the available moving distance according to a variation of a mechanical energy applied by a user when the operation mode of the vehicle uses electric energy of the battery and the mechanical energy applied by the user.
